(19) United States
(12) Patent Application Publication
(10) Pub. No.: US 2003/0030715 A1
(43) Pub. Date: Feb. 13, 2003

(54) Ink-jet printing method and apparatus for manufacturing color filters

(76) Inventors: Kevin Cheng, Miaoli Hsien (TW); Tz-Ya Yang, Taipei (TW); Jessen Chen, Nantou Hsien (TW); Jupiter Hu, Hsichu (TW)

Correspondence Address: BIRCH STEWART KOLASCH & BIRCH, PO BOX 747, FALLS CHURCH, VA, 22040-0747, US

(21) Appl. No.: 09/973,705

(22) Filed: Oct. 11, 2001

(30) Foreign Application Priority Data
Aug. 8, 2001 (TW) 90119416

(51) Int. Cl. B41J 3/407

(52) U.S. Cl. 347/106

(57) ABSTRACT

An ink-jet printing method and apparatus for manufacturing color filters of the invention comprises an printing head module, a table, an air jet module, an optical system, and a controlling system. The table is used to support the filter substrate and move relative to the printing head module. The optical system is used for real-time calibration so the printing head module is able to precisely spray ink droplets to the substrate. An air jet head module is then used to accurately distribute ink droplets. The conventional absorb layer is not necessary. The precision of spraying and distribution of ink droplets are thus much improved over the conventional technique.

### BACKGROUND OF THE INVENTION

1. Field of the Invention

The invention relates to a process and apparatus of ink-jet printing for manufacturing color filters, and especially for a process and apparatus of ink jet printing with real time position tracking and direct air-impinging system to equalize ink distribution on filter substrate.

2. Related Art

There are three main applications for color filters. The first one is an image sensor such as CCD (Charge Coupled Device), the second is a line sensor such as a crystal shutter, and the third is a display such as TN (Twisted Nematic), STN (Super Twisted Nematic) and TFT (Thin Film Transistor) LCD liquid crystal displays. As these products are becoming more and more popular, more color filters need to be produced for the market. Therefore, lowering the cost of color filters is an important issue to be addressed.

Conventionally, there are about four color filter manufacturing processes. All of them require very complicated processes for coloring, cleaning, drying, and etching. It is thus very difficult to lower the cost. The invention of an ink jet process makes it possible to bring down the cost. The ink jet process sprays ink droplets to a black matrix formed with cavities on a filter substrate. Ink droplets with different colors are sprayed on the filter to produce different types of filters. Red, green, and blue colors are generally used as fundamental cells. The difference between the ink jet process and other semiconductor processes is low cost with respect to both apparatus and manufacturing.

However, the ink jet process requires precise positioning so the ink droplets can be discharged to selected positions. In addition, ink droplets poorly diffused inside the cavity cause the problem of white omission between cavities. In order to solve these problems, an absorb layer has been designed. The absorb layer is located between the substrate and ink colorant layer. The ink droplets are able to diffuse to predetermined locations because of the high diffusivity of the absorb layer. Optical positioning calibration is also used to improve positioning.

This method leads to some problems that need to be solved. The absorb layer increases the total cost, and color filter quality is limited because white omission and color mixing occur between cavities due to the ink droplets have not perfect diffused in the absorb layer. Another problem is for real-time locating position; an optical system is used to correct the position shift of ink droplet and the center of color portion on color filter substrate. In this prior-art method, light position sensors mounted with print head for detecting the central positions of the filter elements are provided around the respective discharge orifices on the front surface of the ink-jet head; the analog signal intensity of light sensor is used to decide the correct spray positions. However, the relative position shift between the light source and light sensor may lead to a shift (Diffraction effect for light passing though a slit) of the light peak, high precision location cannot be obtained. Besides, the light sensor and ink jet head integrated in a one print head, it made extra problems such as high cost, inability to clean the ink jet head nozzle when it is jammed (sensor will be contaminated), low nozzle utility rate, etc.

### SUMMARY OF THE INVENTION

In this invention, it provides a solution to manufacture color filter, using the ink-jet printing method. The substrate is located by a first optical system, and the position offset between the filter element and the printing nozzle is dynamically aligned by a second optical system, to make sure that the ink drops will be exactly discharged into the center of each filter element. The coloring step directly discharge ink on the substrate without absorb layer coating. After coloring, an air jet follow applied to impinge on the drop surface to force the ink drops uniformly spread. It will not only make the drop spread uniformly to fill the filter element, but also improve the distribution of thickness in the filter element. To avoid color mixing, the manufacture processes will divide into three major processes for coloring red, green, and blue color inks. Each process includes a preprint step to locate nozzle position, and a coloring step to discharge ink drops into predetermined filter elements.

The ink-jet printing method and apparatus for manufacturing color filters of the invention comprises a printing head module, a table, an air jet module, at least an optical system, and a controlling system. The table is used to support and move the filter substrate. The black matrix on the substrate is formed as a lattice structure that the ink droplets are discharging into. The optical system is used to detect the relative position between the lattice structure, the filter substrate and the ink jet head for real-time position tracking between filter substrate and ink jet head nozzle. The light source of the optical system is mounted beneath the filter substrate. A detection device such as a CCD detects the intensity of light passing through the substrate and converts the analog signal to a digital signal for determining the center position of the lattice structure. Ink droplets are directly discharged on the filter substrate and are blown by an air jet module in order to uniformly distributed ink droplets in the lattice structure. In this case, the absorb layer is not necessary.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given herein below. However, the following description is for purposes of illustration only, and thus is not limitative of the invention, wherein:

FIG. 1 illustrates the invention equipment system.

FIG. 2 illustrates a manufacture process of the invention.

FIGS. 3a and 3b illustrate the first embodiment of signal relationship for the lattice structure and the real-time linear CCD sensors of the invention.

FIGS. 4a and 4b illustrate the second embodiment of signal relationship for the lattice structure and the real-time linear CCD sensors of the invention.

FIG. 5 illustrates the components of the air jet module of the invention.

FIGS. 6a-6c illustrate the ink droplets formation and being equalized uniformly distribution on the substrate in the invention.

FIG. 7 illustrates a two-dimension air impinging jet theory of the invention.

FIGS. 8a and 8b illustrate the assignment of air jet nozzle of the invention.

### DETAILED DESCRIPTION OF THE INVENTION

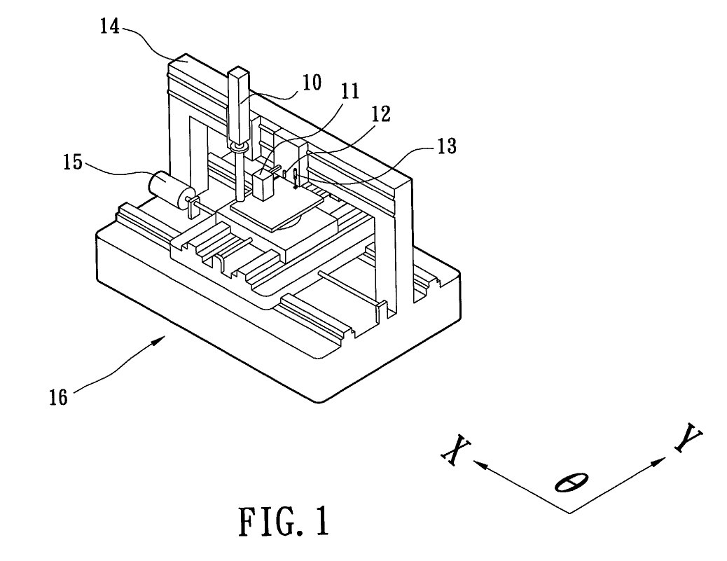

FIG. 1 illustrates the ink-jet printing method and apparatus for manufacturing color filters disclosed in the invention. The invention comprises a printing head module 11, a table 16, an air jet module 12, an optical system and a controlling system. The printing head module 11 at least comprises a nozzle. Each nozzle is responsible for one color (There are generally red, green, and blue colors) and discharges ink droplets to the substrate 17. The table 16 supports the substrate 17 so the printing head module 11 is able to discharge ink droplets to this substrate 17. The motors 15 (one for each axis) connect to moving mechanism such as a stage for moving the substrate 17 in the X-Y-θ directions. Here the X direction is defined as the direction parallel to the support 14, the Y direction as the one vertical to the support 14, and a rotary stage (X-Y plane) positioned to rotate the substrate 17 in θ direction. All the parts 10, 11, 12, and 13 hung on the support 14 are adjustable. This apparatus is supported on a granite base with four vibration isolators to absorb vibration. A computer-based controller (not show in FIG. 1) controls overall operation of manufacture processes.

The optical system comprises a first optical module 13 and a second optical module 10 for detecting the relative position shift between the substrate 17 and the nozzle of the printing head module 11. The first optical module 13 is used for detecting the position of the substrate 17, which could be, for example, an area CCD. The second optical module 10 is used for detecting the relative position shift between the nozzle of the printing head module 11 and the ink dots discharging on color portion of substrate. In other words, the first optical module 13 is used for initial positioning calibration and the second optical module 10 is then used for real-time and precise position tracking.

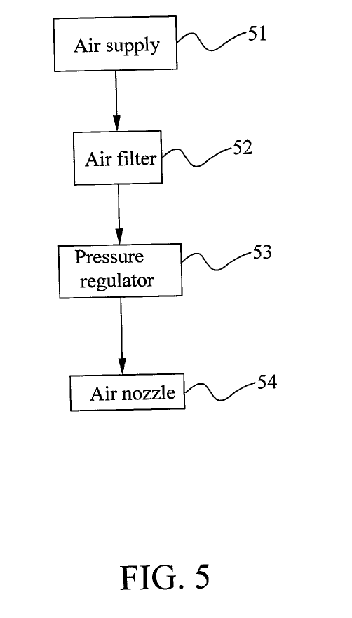

The air jet module 12 is used to blow and accurately distribute ink droplets sprayed on the substrate 17. Referring to FIG. 5, the air jet module 12 comprises an air supply 51, an air filter 52, a pressure regulator 53, and an air nozzle 54. The air supply 51 is used to blow air having the required pressure and the air filter 52 is used to filter air so water and any impurities can be removed from the blowing air to prevent ink droplets from being contaminated. The pressure regulator 53 is used to control the air pressure and the air nozzle 54 is for blowing air. The control system is used to control the motion of every unit including the printing head module 11, the table 16, the air jet module 12 and the optical CCD system. The control system can be a computer-based system (not shown in the figures).

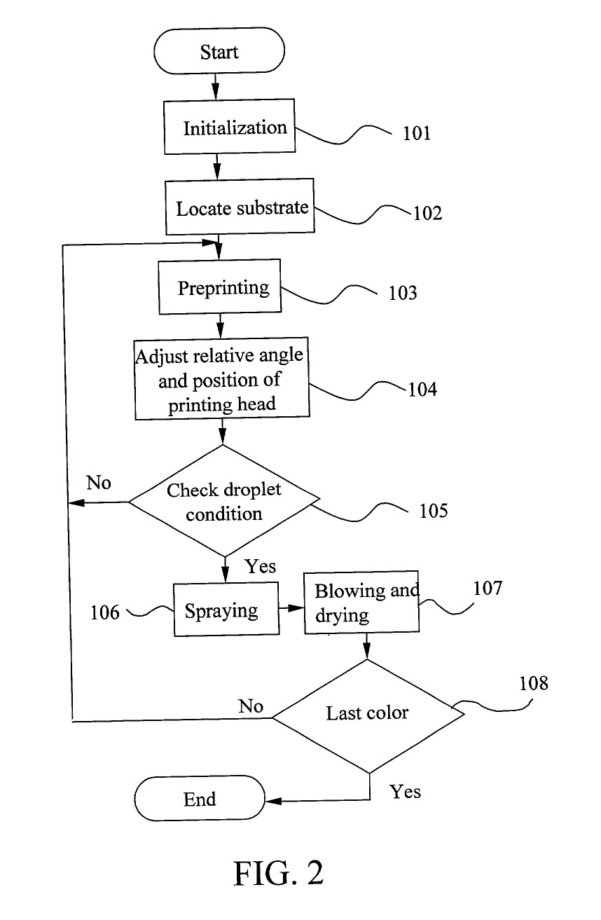

As shown in FIG. 2 of the manufacture processes block diagram. At initialization (step 101), a substrate to be colored by this apparatus is loaded and fixed onto the substrate carrier (not shown). The first optical module 13 is used to locate the substrate 17 (step 102). It reads the position of the alignment mark on the substrate, and then calculates the position offset caused by loading the substrate. The substrate is then aligned by driving motors to move X-Y-θ stages. When the step F102 is completed, a preprinting operation F103 is performed. The object of the preprinting is to locate a reference nozzle position and check printing condition by discharging ink droplets to a specific blank test area of the substrate 17. The reference nozzle is selected and predetermined for each print head. During this pre-printing step, a discharging failure is checked on the basis of the color filter pattern. This checking step is conducted by processing image data indicating whether an ink dot from a nozzle discharged on substrate is acceptable (step F105). If no discharging failure is detected, then go to next step. The relative position/angle (step 104) of the print head (relative to the substrate 17) and the ink droplets discharged from the reference nozzle can then be accurately adjusted. If the discharging is unaccepted, then adjust, clean or replace the printing module, and repeat steps F103 to F105.

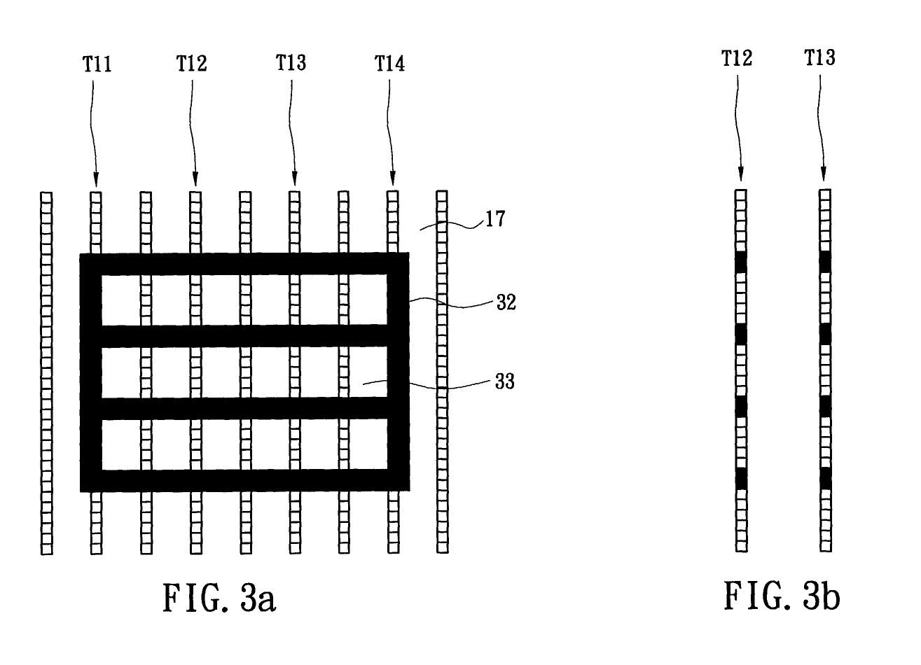

Please refer to FIG. 3a shows a real-time tracking scheme to correct position offset in printing process. In FIG. 3a, it includes a lattice window structure of black matrix 32 and three color portions 33 for red, green and blue color. This basic element size determines the resolution of a color filter. The ink-jet head prints the filter elements while the substrate moving relative to it. Upon this scanning, the substrate is moving relative to the 1 second optical module 10 from right to left, the second optical module 10 then get the scanning data array from T11 to T14 in time sequence. The signal in black matrix portion 32 and color portion 33 will be different for receiving of light into linear CCD pixels.

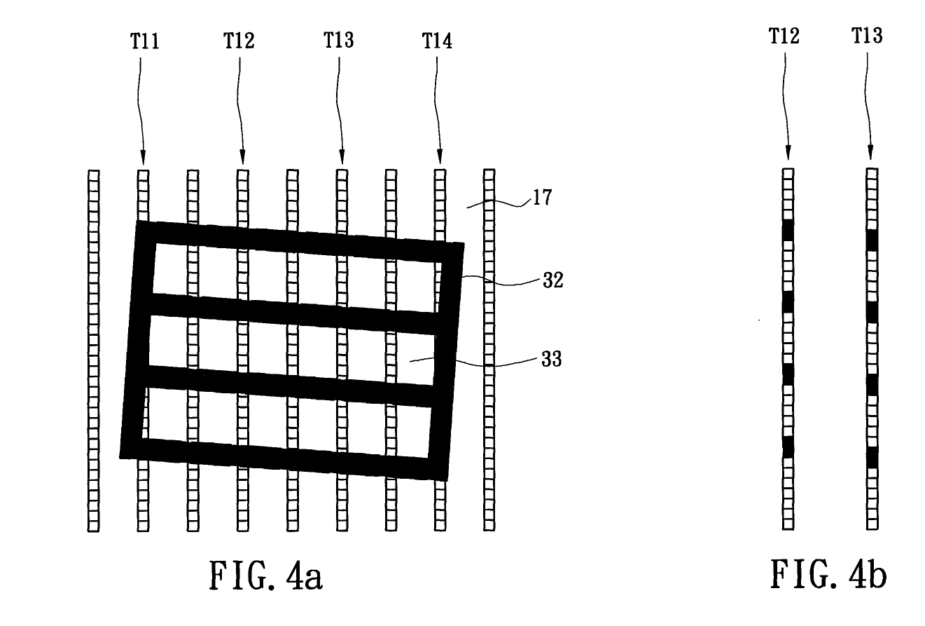

The second optical module 10 receives light intensity generated by the light source (not shown in the figures) underneath the substrate 17 passes through the substrate 17. The light source can be a light source or a back light source (the first optical module 13 can be designed the same way for the latter). When the second optical module 10 receives the analog signal of light, it digitalizes the signal. For example, the digital signal is set to 1 (the color portion 33) if the light intensity is more than a particular threshold value, and the signal is set to 0 (lattice structure frame) if the light intensity is below a particular threshold value. Since light passes through the substrate 17, the light in the lattice structure position 32 is not able to pass through while light in the color portion 33 is able to pass through. The signals detected by the second optical module 10 at different times are T11, T12, T13, and T14 in time sequence. Because the lattice structure 32 is a fixed structure, we can set a critical value in advance for determining where the color portion 33 and the lattice structure 32 are. For example, it is recognized as the frame (T11) of the lattice structure 32 if signal 0 in the detection track is more than a certain critical value (for example, 60%). The area between frame T11 and frame T13 (the next position at which signal 0 is over the critical value) is regarded as color portion 33. The lattice structure is a two dimensional black matrix. The other detection tracks T12 and T13 are used to determine the angle shift of the lattice structure 32. The signal detected by the second optical module is shown in FIG. 3b—black area means the signal is 0. After positioning where the signals 0 in T12 and T13 are, we can know the angle shift of the lattice structure. As shown in FIGS. 4a and 4b, for example, if the magnitude of linear CCD is 1 μm/pixel, and the time different between T12 and T13 is Δt. The substrate is moving in a speed of V mm/s. The angle δ can be calculated as Sin⁻¹ (Offset Count *(1 μm/pixel)/(Δt*V mm/s)), where the offset count is the bit data shifting from T12 to T13. In the position tracking system having above construction, the controller will move the substrate to align the Y-direction center position of color portion shifting from discharging nozzles. However, the lattice structure is not limited to only four detection tracks.

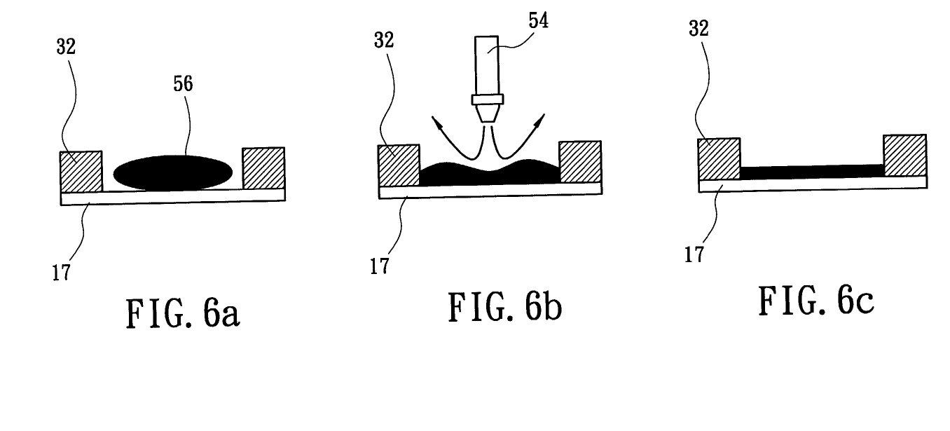

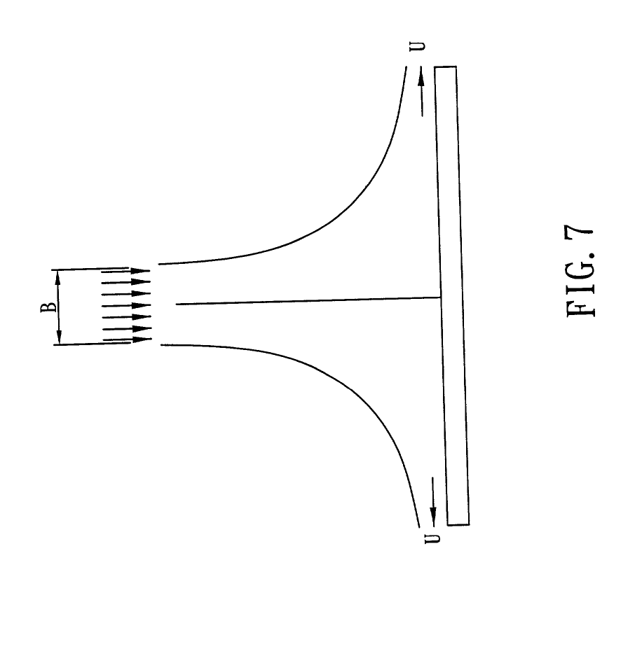

After the calibration and test printing have been done, the printing process (step 106) is performed. The nozzles will discharge ink droplets at the predetermined position to fill the filter elements. Ink droplets are discharging into the lattice structure 33 and then the air jet module 12 is used to blow ink droplets to uniformly distribute drops (step 107). This design will not only equalize the distribution of colorant in a filter element, but also dries the ink drops in the same time. Referring to FIGS. 6a-6c, ink droplets 56 are discharged on the substrate 17 and an air jet module 12 is used to blow air onto the ink droplets in order to have uniformly distributed ink droplets. The air stream distribution is illustrated in FIG. 7. The magnitude of the normal force exerted on the wall at right angle by the jet is expressed as F=ρU²B, where the F is force perpendicularly acting on the surface of the substrate 17, ρ is air density, U is air speed, and B is jet area. A suitable air pressure can be calculated by the above equation and controlled by a pressure regulator 53. At the same time, a heater can be added to the air jet module 12 so hot air is blown out to dry ink droplets when doing drop distribution.

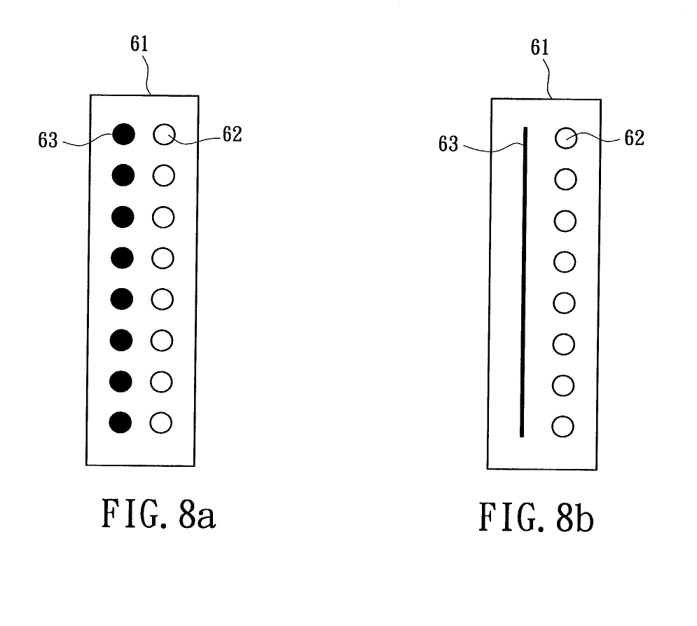

Subsequently, determine if it is the last color (step 108) until all ink droplets colors are discharged. Additionally, during the steps F101 to F108, the second optical module 10 is used for real-time calibration when the printing process F106 needs more high position precision. The air jet module 12 and the printing head module 11 can be integrated into a one-piece system. Referring to FIGS. 8a and 8b, the ink jet head 61 contains the ink jet nozzle 62 to discharge ink droplets and the air jet nozzle 63 to equalize ink droplets after ink droplets are discharged. The air jet nozzle can be designed as a round or slit opening area with the same function.

The following are advantages for the process and apparatus of ink jet printing for producing color filters of the invention:

1. The conventional absorb layer is not required so the production cost is reduced and the processes are reduce. An air jet is designed for proper distribution of ink droplets.

2. The optical CCD system has a special design with a light source located underneath the substrate, so light can pass though the substrate without the errors caused by reflection in the conventional technology.

3. The optical CCD system has real-time positioning ability so high precision can be achieved when printing.

4. The optical CCD system uses digital signal to discriminate the black matrix and color portion, so the error shift caused by diffraction of light wave with the conventional analog technique can be avoided.

5. The optical inspection and the printing head module are separated so it is easier to clean the ink jet head.

6. The air jet flow is designed to equalize the ink droplet profile, besides, the air jet flow can be heated so the hot air flow can dry ink droplets much faster.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An ink-jet printing apparatus for manufacturing color filters, comprises:
a printing head module for discharging ink droplets directly to a color filter substrate, having at least one nozzle and each color discharged by individual printing head;
a table for supporting said color filter substrate moving relatively to said printing head module;
an air jet module located at one side of said print head module for blowing air to ink droplets discharged on said filter substrate for equalizing ink droplets uniformly;
an optical system for detecting the position of said color filter substrate; and
a controlling system for controlling said printing head module, said table and said optical system.

2. The apparatus of claim 1, wherein said air jet module and said ink jet module are integrated together.

3. The apparatus of claim 1, wherein said air jet module contains a heater for heating air so hot air can be blown out and dry ink droplets.

4. The apparatus of claim 1, wherein said air jet nozzle has a round outlet.

5. The apparatus of claim 1, wherein said air jet nozzle has a slit outlet.

6. The apparatus of claim 1, wherein said optical system comprises:
a first optical module for detecting the position of said color filter substrate; and
a second optical module for real-time detecting relative position between said ink droplet and the center of color portion on color filter substrate, and said relative position by determining light intensity after light generated by a light source beneath said substrate and passes through said substrate.

7. The apparatus of claim 1, wherein said the color portion is a frame of a lattice structure on the color filter substrate, wherein the said lattice structure is constructed by black matrix.

8. An ink-jet printing method for manufacturing color filters, comprises following steps:
locating a color filter substrate and a nozzle;
tracking the relative position in real time between said ink droplet and the center of color portion on color filter substrate;
discharging an ink droplet on color portion of substrate; and
blowing air to said ink droplet for equalizing ink droplets uniformly.

9. The method of claim 8, wherein said color portion is a frame of a lattice structure on the color filter substrate, and wherein the said lattice structure is constructed by black matrix.

10. The method of claim 8, wherein said real time calibration is performed to determine the relative position of said ink droplet and the center of color portion on color filter substrate by determining light intensity after light generated by a light source beneath said substrate and passes through said substrate.

11. The method of claim 8, wherein the step of blowing air to said ink droplet for equalizing ink droplets uniformly further comprises a step for drying said ink drop.
